(19) United States
(12) Patent Application Publication
(10) Pub. No.: US 2021/0285121 A1
(43) Pub. Date: Sep. 16, 2021

(54) Systems and Methods for Treating a Metal Substrate

(71) Applicant: PRC-DeSoto International, Inc., Sylmar, CA (US)

(72) Inventors: Anaïs Mauricette Christiana Flegny, Le Havre (FR); Eric L. Morris, Murrieta, CA (US); Gordon L. Post, Pittsburgh, PA (US); John D. Suter, II, Avon Lake, OH (US); Michael A. Mayo, Pittsburgh, PA (US)

(73) Assignee: PRC-DeSoto International, Inc., Sylmar, CA (US)

(21) Appl. No.: 16/324,944

(22) PCT Filed: Aug. 14, 2017
(86) PCT No.: PCT/US2017/046714

§ 371 Date: Feb. 12, 2019

(51) Int. Cl. C25D 11/24; C25D 11/16; C23C 22/66

(52) U.S. Cl. CPC C25D 11/246; C23C 22/66; C25D 11/16

(57) ABSTRACT

Disclosed is a method for treating an anodized metal substrate, including contacting at least a portion of the substrate surface with a sealing composition having a pH of 9.5 to 12.5 and comprising a lithium metal cation. Also disclosed is a system that includes a sealing composition having a pH of 9.5 to 12.5 and comprising a lithium metal cation and an aqueous composition for contacting a surface of the metal substrate following contacting with the sealing composition. Also disclosed are substrates treated with the system and method.

### CROSS-REFERENCE TO RELATED APPLICATION

This application claims priority to U.S. Provisional Application No. 62/374,188, entitled “Sealing Composition” and filed on Aug. 12, 2016, incorporated herein by reference in its entirety.

### FIELD

The present invention relates to systems and methods for treating a metal substrate. The present invention also relates to a coated metal substrate.

### BACKGROUND

The oxidation and degradation of metals used in aerospace, commercial, and private industries are a serious and costly problem. To prevent the oxidation and degradation of the metals used in these applications, an inorganic protective coating can be applied to the metal surface. This inorganic protective coating, also referred to as a conversion coating, may be the only coating applied to the metal surface, or the coating can be an intermediate coating to which subsequent coatings are applied. Corrosion protection of anodized substrates has been particularly problematic. Water-sealing steps do not adequately protect anodized substrates from corrosion. Chromate-based sealing compositions and processes using the same provide good corrosion protection. However, due to environmental concerns over chromium-based compounds in the environment, there is a need for an environmentally safer replacement for chromate-based conversion coatings. There is also a need for environmentally safer compositions and methods that can provide corrosion resistance to an underlying anodized metal surface.

### SUMMARY

Disclosed herein is a method of treating a substrate comprising contacting at least a portion of the substrate surface with a sealing composition having a pH of 9.5 to 12.5 and comprising a lithium metal cation; wherein at least a portion of the substrate surface is anodized.

Also disclosed herein is a system for treating a metal substrate comprising a sealing composition having a pH of 9.5 to 12.5 and comprising a lithium metal cation; and an aqueous composition comprising a conditioner.

Also disclosed are substrates treated with the disclosed system and/or method of treating.

### BRIEF DESCRIPTION OF THE FIGURES

FIG. 1 shows a TEM image of an anodized panel immersed in lithium carbonate (0.15% lithium carbonate salt) for 2 minutes followed by immersion in deionized water (100° C.) for 60 minutes.

FIG. 2A shows an XPS survey scan of the surface of the substrate shown in FIG. 1. The scan shows that no lithium is detected on the surface as indicated by the lack of a peak at the position marked “Li 1S”.

FIG. 2B shows an XPS depth profile of the substrate for lithium shown in FIG. 1—the depth profile shows a depth profile from 0 to 400 nm (line having high peak at 54 eV binding energy) superimposed over a depth profile from 400 to 800 nm (relatively flat line trending downwards to 52 eV). The two-plots are averages throughout the surface with measurements taken every 50 nm. The data indicates there is lithium present in the 0 to 400 nm depth range and no lithium present in the 400 to 800 nm depth range.

FIG. 2C shows the summed lithium is spectra of the XPS depth profile of the data shown in FIG. 2B. The data shows the presence of lithium in the 0 to 400 nm depth range and a lack of lithium in the 400 to 800 nm depth range.

FIG. 3 shows a schematic illustrating thickness of a layer of the sealing composition on a substrate surface.

FIG. 4 shows corrosion performance of anodized panels immersed the sealing composition of the present invention following 216 hours exposure to neutral salt spray.

### DETAILED DESCRIPTION

As mentioned above, the present invention is directed to a method of treating a substrate comprising, or in some instances, consisting essentially of, or in some instances, consisting of: contacting at least a portion of the substrate surface with a sealing composition having a pH of 9.5 to 12.5 and comprising, or in some instances, consisting essentially of, or in some instances, consisting of, a lithium metal cation; wherein at least a portion of the substrate surface is anodized. The present invention also is directed to a system for treating a metal substrate, the system comprising, or in some instances, consisting essentially of, or in some instances, consisting of, a sealing composition having a pH of 9.5 to 12.5 and comprising, or in some instances, consisting essentially of, or in some instances, consisting of, a lithium metal cation, and an aqueous composition comprising, or in some instances, consisting essentially of, or in some instances, consisting of, an aqueous composition comprising a conditioner; wherein at least a portion of the substrate surface is anodized. According to the present invention, as set forth in more detail below, the system may be substantially free, or in some instances essentially free, or in some instances completely free, of chromium or chromium-containing compounds (defined below) and/or phosphate ions and/or phosphate-containing compounds (defined below) and/or fluoride.

As used herein, “anodized” or “anodizing,” when used with respect to a method of treating a substrate surface, means an electrochemical conversion process that forms an oxide film (i.e., a porous structure that grows out of the substrate surface) on a substrate surface in an electrolyte, wherein the substrate serves as the anode and current is passed between the anode and a cathode. As used herein, “anodized,” when used with respect to a substrate surface, means a substrate that has an oxide film formed on the substrate surface by an anodizing process. In examples, according to the present invention, anodization may be by simple acids or a blend of acids, including but not limited to, phosphoric acid, sulfuric acid, chromic acid, boric acid, tartaric sulfuric acid, and/or oxalic acid, and optionally may be a duplex of steps. In examples, the anodization process may be carried out at 15-60C for 10-30 minutes at 5V to 60V.

Suitable substrates that may be used in the present invention include metal substrates, metal alloy substrates, and/or substrates that have been metallized, such as nickel plated plastic. According to the present invention, the metal or metal alloy can comprise or be aluminum, zinc, nickel, titanium, magnesium, niobium, tantalum, zirconium and/or hafnium. Aluminum alloys of the 1XXX, 2XXX, 3XXX, 4XXX, 5XXX, 6XXX, or 7XXX series as well as clad aluminum alloys also may be used as the substrate. Aluminum alloys may comprise 0.01% by weight copper to 10% by weight copper. Aluminum alloys which are treated may also include castings, such as 1XX.X, 2XX.X, 3XX.X, 4XX.X, SXX.X, 6XX.X, 7XX.X, 8XX.X, or 9XX.X (e.g.: A356.0). Magnesium alloys of the AZ31B, AZ91C, AM60B, or EV31A series also may be used as the substrate. The substrate used in the present invention may also comprise titanium and/or titanium alloys, zinc and/or zinc alloys, and/or zirconium and/or zirconium alloys. According to the present invention, the substrate may comprise a portion of a vehicle such as a vehicular body (e.g., without limitation, door, body panel, trunk deck lid, roof panel, hood, roof and/or stringers, rivets, landing gear components, and/or skins used on an aircraft) and/or a vehicular frame. As used herein, “vehicle” or variations thereof includes, but is not limited to, civilian, commercial and military aircraft, and/or land vehicles such as cars, motorcycles, and/or trucks.

As mentioned above, the sealing composition of the present invention may comprise a lithium metal cation. The sealing composition of the present invention also may further comprise a metal cation of a Group IA metal other than lithium, a Group VB metal cation, a Group VIB metal cation, or combinations thereof.

The lithium metal cation, the Group IA metal cation other than lithium metal cation, the Group VB metal cation, and/or the Group VIB metal cation may be in the form of a salt. Non-limiting examples of anions suitable for forming a salt with any of the aforementioned metal cations include carbonates, hydroxides, nitrates, halogens, sulfates, phosphates and silicates (e.g., orthosilicates and metasilicates) such that the metal salt may comprise a carbonate, an hydroxide, a nitrate, a halide, a sulfate, a phosphate, a silicate (e.g., orthosilicate or metasilicate), a permanganate, a chromate, a vanadate, a molybdate, and/or a perchlorate.

According to the present invention, the metal salts sealing composition (i.e., the salts of lithium, Group IA metals other than lithium, Group VB metals, and/or Group VIB metals) each may be present in the sealing composition in an amount of at least 25 ppm, such as at least 150 ppm, such as at least 500 ppm (calculated as total compound) based on total weight of the sealing composition, and in some instances, no more than 30000 ppm, such as no more than 2000 ppm, such as no more than 1500 ppm (calculated as total compound) based on total weight of the sealing composition. According to the present invention, the metal salts (i.e., the salts of lithium, Group IA metals other than lithium, Group VB metals, and/or Group VIB metals) of the sealing composition may be present in the sealing composition in an amount of 25 ppm to 30000 ppm, such as 150 ppm to 2000 ppm, such as 500 ppm to 1500 (calculated as total compound) based on total weight of the sealing composition.

According to the present invention, the lithium metal cation, Group IA metal cations other than lithium, the Group VB metal cation, and the Group VIB metal cation each may be present in the sealing composition in an amount of at least 5 ppm, such as at least 50 ppm, such as at least 150 ppm, such as at least 250 ppm (calculated as metal cation) based on total weight of the sealing composition, and in some instances, may be present in an amount of no more than 5500 ppm, such as no more than 1200 ppm, such as no more than 1000 ppm, such as no more than 500 ppm, (calculated as metal cation) based on total weight of the sealing composition. In some instances, according to the present invention, the lithium metal cation, Group IA metal cations other than lithium, the Group VB metal cation, and the Group VIB metal cation each may be present in the sealing composition in an amount of 5 ppm to 5500 ppm, such as 50 ppm to 1000 ppm, (calculated as metal cation) based on total weight of the sealing composition, such as 150 ppm to 500 ppm.

According to the present invention, the lithium salt of the present invention may comprise an inorganic lithium salt, an organic lithium salt, or combinations thereof. According to the present invention, the anion and the cation of the lithium salt both may be soluble in water. According to the present invention, for example, the lithium salt may have a solubility constant in water at a temperature of 25° C. (K; 25° C.) of at least 1×10⁻¹¹, such as least 1×10⁻⁴, and in some instances, may be no more than 5×10⁺². According to the present invention, the lithium salt may have a solubility constant in water at a temperature of 25° C. (K; 25° C.) of 1×10⁻¹¹ to 5×10⁺², such as 1×10⁻⁴ to 5×10⁺². As used herein, “solubility constant” means the product of the equilibrium concentrations of the ions in a saturated aqueous solution of the respective lithium salt. Each concentration is raised to the power of the respective coefficient of ion in the balanced equation. The solubility constants for various salts can be found in the Handbook of Chemistry and Physics.

According to the present invention, the sealing composition of the present invention may an include oxidizing agent, such as hydrogen peroxide, persulfates, perchlorates, sparged oxygen, bromates, peroxi-benzoates, ozone, and the like, or combinations thereof. For example, the sealing composition may comprise 0.1 wt % to 15 wt % of an oxidizing agent based on total weight of the sealing composition, such as 2 wt % to 10 wt %, such as 6 wt % to 8 wt %.

Alternatively, according to the present invention, the sealing composition may be substantially free, or in some cases, essentially free, or in some cases, completely free, of an oxidizing agent.

According to the present invention, the sealing composition may exclude Group IIA metal cations or Group IIA metal-containing compounds, including but not limited to calcium. Non-limiting examples of such materials include Group IIA metal hydroxides, Group IIA metal nitrates, Group IIA metal halides, Group IIA metal sulfamates, Group IIA metal sulfates, Group IIA carbonates and/or Group IIA metal carboxylates. When a sealing composition and/or a coating or a layer, respectively, formed from the same is substantially free, essentially free, or completely free of a Group IIA metal cation, this includes Group IIA metal cations in any form, such as, but not limited to, the Group IIA metal-containing compounds listed above.

According to the present invention, the sealing composition may exclude chromium or chromium-containing compounds. As used herein, the term “chromium-containing compound” refers to materials that include hexavalent chromium. Non-limiting examples of such materials include chromic acid, chromium trioxide, chromic acid anhydride, dichromate salts, such as ammonium dichromate, sodium dichromate, potassium dichromate, and calcium, barium, magnesium, zinc, cadmium, and strontium dichromate. When a sealing composition and/or a coating or a layer, respectively, formed from the same is substantially free, essentially free, or completely free of chromium, this includes chromium in any form, such as, but not limited to, the hexavalent chromium-containing compounds listed above.

Thus, optionally, according to the present invention, the present sealing compositions and/or coatings or layers deposited from the same may be substantially free, may be essentially free, and/or may be completely free of one or more of any of the elements or compounds listed in the preceding paragraph. A sealing composition and/or coating or layer formed from the same that is substantially free of chromium or derivatives thereof means that chromium or derivatives thereof are not intentionally added, but may be present in trace amounts, such as because of impurities or unavoidable contamination from the environment. In other words, the amount of material is so small that it does not affect the properties of the sealing composition; in the case of chromium, this may further include that the element or compounds thereof are not present in the sealing compositions and/or coatings or layers formed from the same in such a level that it causes a burden on the environment. The term “substantially free” means that the sealing compositions and/or coating or layers formed from the same contain less than 10 ppm of any or all of the elements or compounds listed in the preceding paragraph, based on total weight of the composition or the layer, respectively, if any at all. The term “essentially free” means that the sealing compositions and/or coatings or layers formed from the same contain less than 1 ppm of any or all of the elements or compounds listed in the preceding paragraph, if any at all. The term “completely free” means that the sealing compositions and/or coatings or layers formed from the same contain less than 1 ppb of any or all of the elements or compounds listed in the preceding paragraph, if any at all.

According to the present invention, the sealing composition may, in some instances, exclude phosphate ions or phosphate-containing compounds and/or the formation of sludge, such as aluminum phosphate, iron phosphate, and/or zinc phosphate, formed in the case of using a treating agent based on zinc phosphate. As used herein, “phosphate-containing compounds” include compounds containing the element phosphorous such as ortho phosphate, pyrophosphate, metaphosphate, tripolyphosphate, organophosphonates, and the like, and can include, but are not limited to, monovalent, divalent, or trivalent cations such as: sodium, potassium, calcium, zinc, nickel, manganese, aluminum and/or iron. When a composition and/or a layer or coating comprising the same is substantially free, essentially free, or completely free of phosphate, this includes phosphate ions or compounds containing phosphate in any form.

Thus, according to the present invention, sealing composition and/or layers deposited from the same may be substantially free, or in some cases may be essentially free, or in some cases may be completely free, of one or more of any of the ions or compounds listed in the preceding paragraph. A sealing composition and/or coatings or layers deposited from the same that is substantially free of phosphate means that phosphate ions or compounds containing phosphate are not intentionally added, but may be present in trace amounts, such as because of impurities or unavoidable contamination from the environment. In other words, the amount of material is so small that it does not affect the properties of the composition; this may further include that phosphate is not present in the sealing compositions and/or coatings or layers deposited from the same in such a level that they cause a burden on the environment. The term “substantially free” means that the sealing compositions and/or coatings or layers deposited from the same contain less than 5 ppm of any or all of the phosphate anions or compounds listed in the preceding paragraph, based on total weight of the composition and/or coatings or layers, if any at all. The term “essentially free” means that the sealing compositions and/or coatings or layers comprising the same contain less than 1 ppm of any or all of the phosphate anions or compounds listed in the preceding paragraph. The term “completely free” means that the sealing compositions and/or coatings or layers comprising the same contain less than 1 ppb of any or all of the phosphate anions or compounds listed in the preceding paragraph, if any at all.

According to the present invention, the sealing composition may, in some instances, exclude fluoride or fluoride sources. As used herein, “fluoride sources” include monofluorides, bifluorides, fluoride complexes, and mixtures thereof known to generate fluoride ions. When a composition and/or a layer or coating comprising the same is substantially free, essentially free, or completely free of fluoride, this includes fluoride ions or fluoride sources in any form, but does not include unintentional fluoride that may be present in a bath as a result of, for example, carry-over from prior treatment baths in the processing line, municipal water sources (e.g.: fluoride added to water supplies to prevent tooth decay), fluoride from a pretreated substrate, or the like. That is, a bath that is substantially free, essentially free, or completely free of fluoride, may have unintentional fluoride that may be derived from these external sources, even though the composition used to make the bath prior to use on the processing line was substantially free, essentially free, or completely free of fluoride.

For example, the sealing composition may be substantially free of any fluoride-sources, such as ammonium and alkali metal fluorides, acid fluorides, fluoroboric, fluorosilicic, fluorotitanic, and fluorozirconic acids and their ammonium and alkali metal salts, and other inorganic fluorides, nonexclusive examples of which are: zinc fluoride, zinc aluminum fluoride, titanium fluoride, zirconium fluoride, nickel fluoride, ammonium fluoride, sodium fluoride, potassium fluoride, and hydrofluoric acid, as well as other similar materials known to those skilled in the art.

Fluoride present in the sealing composition that is not bound to metals ions such as Group IVB metal ions, or hydrogen ion, defined herein as “free fluoride,” may be measured as an operational parameter in the sealing composition bath using, for example, an Orion Dual Star Dual Channel Benchtop Meter equipped with a fluoride ion selective electrode (“ISE”) available from Thermoscientific, the Symphony® Fluoride Ion Selective Combination Electrode supplied by VWR International, or similar electrodes. See, e.g., Light and Cappuccino, Determination of fluoride in toothpaste using an ion-selective electrode, J. Chem. Educ., 52:4, 247-250, April 1975. The fluoride ISE may be standardized by immersing the electrode into solutions of known fluoride concentration and recording the reading in millivolts, and then plotting these millivolt readings in a logarithmic graph. The millivolt reading of an unknown sample can then be compared to this calibration graph and the concentration of fluoride determined. Alternatively, the fluoride ISE can be used with a meter that will perform the calibration calculations internally and thus, after calibration, the concentration of the unknown sample can be read directly.

Fluoride ion is a small negative ion with a high charge density, so in aqueous solution it is frequently complexed with metal ions having a high positive charge density, such as Group IVB metal ions, or with hydrogen ion. Fluoride anions in solution that are ionically or covalently bound to metal cations or hydrogen ion are defined herein as “bound fluoride.” The fluoride ions thus complexed are not measurable with the fluoride ISE unless the solution they are present in is mixed with an ionic strength adjustment buffer (e.g.: citrate anion or EDTA) that releases the fluoride ions from such complexes. At that point (all of) the fluoride ions are measurable by the fluoride ISE, and the measurement is known as “total fluoride”. Alternatively, the total fluoride can be calculated by comparing the weight of the fluoride supplied in the sealer composition by the total weight of the composition.

According to the present invention, the treatment composition may, in some instances, be substantially free, or in some instances, essentially free, or in some instances, completely free, of cobalt ions or cobalt-containing compounds. As used herein, “cobalt-containing compounds” include compounds, complexes or salts containing the element cobalt such as, for example, cobalt sulfate, cobalt nitrate, cobalt carbonate and cobalt acetate. When a composition and/or a layer or coating comprising the same is substantially free, essentially free, or completely free of cobalt, this includes cobalt ions or compounds containing cobalt in any form.

According to the present invention, the treatment composition may, in some instances, be substantially free, or in some instances, essentially free, or in some instances, completely free, of vanadium ions or vanadium-containing compounds. As used herein, “vanadium-containing compounds” include compounds, complexes or salts containing the element vanadium such as, for example, vanadates and decavanadates that include counterions of alkali metal or ammonium cations, including, for example, sodium ammonium decavanadate. When a composition and/or a layer or coating comprising the same is substantially free, essentially free, or completely free of vanadium, this includes vanadium ions or compounds containing vanadium in any form free of Ca²⁺

According to the present invention, the sealing composition may optionally further contain an indicator compound, so named because it indicates, for example, the presence of a chemical species, such as a metal ion, the pH of a composition, and the like. An “indicator”, “indicator compound”, and like terms as used herein refer to a compound that changes color in response to some external stimulus, parameter, or condition, such as the presence of a metal ion, or in response to a specific pH or range of pHs.

The indicator compound used according to the present invention can be any indicator known in the art that indicates the presence of a species, a particular pH, and the like. For example, a suitable indicator may be one that changes color after forming a metal ion complex with a particular metal ion. The metal ion indicator is generally a highly conjugated organic compound. A “conjugated compound” as used herein, and as will be understood by those skilled in the art, refers to a compound having two double bonds separated by a single bond, for example two carbon-carbon double bonds with a single carbon-carbon bond between them. Any conjugated compound can be used according to the present invention.

Similarly, the indicator compound can be one in which the color changes upon change of the pH; for example, the compound may be one color at an acidic or neutral pH and change color in an alkaline pH, or vice versa. Such indicators are well known and widely commercially available. An indicator that “changes color upon transition from a first pH to a second pH” (i.e., from a first pH to a second pH that is more or less acidic or alkaline) therefore has a first color (or is colorless) when exposed to a first pH and changes to a second color (or goes from colorless to colored) upon transition to a second pH (i.e., one that is either more or less acidic or alkaline than the first pH). For example, an indicator that “changes color upon transition to a more alkaline pH (or less acidic pH) goes from a first color/colorless to a second color/color when the pH transitions from acidic/neutral to alkaline. For example, an indicator that “changes color upon transition to a more acidic pH (or less alkaline pH) goes from a first color/colorless to a second color/color when the pH transitions from alkaline/neutral to acidic.

Non-limiting examples of such indicator compounds include methyl orange, xylenol orange, catechol violet, bromophenol blue, green and purple, eriochrome black T, Celestine blue, hematoxylin, calmagite, gallocyanine, and combinations thereof. Optionally, the indicator compound may comprise an organic indicator compound that is a metal ion indicator. Nonlimiting examples of indicator compounds include those found in Table 1. Fluorescent indicators, which will emit light in certain conditions, can also be used according to the present invention, although the use of a fluorescent indicator also may be specifically excluded. That is, alternatively, conjugated compounds that exhibit fluorescence are specifically excluded. As used herein, “fluorescent indicator” and like terms refer to compounds, molecules, pigments, and/or dyes that will fluoresce or otherwise exhibit color upon exposure to ultraviolet or visible light. To “fluoresce” will be understood as emitting light following absorption of shorter wavelength light or other electromagnetic radiation. Examples of such indicators, often referred to as “tags,” include acridine, anthraquinone, coumarin, diphenylmethane, diphenylnaphthlymethane, quinoline, stilbene, triphenylmethane, anthracine and/or molecules containing any of these moieties and/or derivatives of any of these such as rhodamines, phenanthridines, oxazines, fluorones, cyanines and/or acridines.

TABLE 1

| | | CAS |
|---|---|---|
| Compound | Structure | Reg. No. |
| Catechol Violet Synonyms: Catechol- sulfonphthalein; Pyrocatechol- sulfonephthalein; Pyrocatechol Violet | 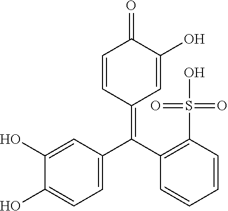 [SMILES: O=C1C=C/C(=C(\c2ccc(O)c(O)c2)c2ccccc2S(=O)(=O)O)C=C1O] | 115-41-3 |
| Xylenol Orange Synonym: 3,3′-Bis[N,N-bis (carboxymethyl) aminomethyl]- o-cresol- sulfonephthalein tetrasodium salt | 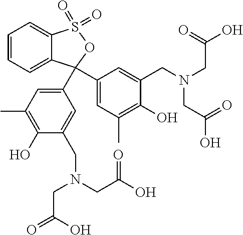 [SMILES: Cc1cc(C2(c3cc(C)c(O)c(CN(CC(=O)O)CC(=O)O)c3)OS(=O)(=O)c3ccccc32)cc(CN(CC(=O)O)CC(=O)O)c1O] | 3618-43-7 |

According to the present invention, the conjugated compound useful as indicator may for example comprise catechol violet, as shown in Table 1. Catechol violet (CV) is a sulfone phthalein dye made from condensing two moles of pyrocatechol with one mole of o-sulfobenzoic acid anhydride. It has been found that CV has indicator properties and when incorporated into compositions having metal ions, it forms complexes, making it useful as a complexiometric reagent. As the composition containing the CV chelates metal ions coming from the metal substrate (i.e., those having bi- or higher valence), a generally blue to blue-violet color is observed.

Xylenol orange, as shown in Table 1 may likewise be employed in the compositions according to the present invention. It has been found that xylenol orange has metal ion (i.e., those having bi- or higher valence) indicator properties and when incorporated into compositions having metal ions, it forms complexes, making it useful as a complexiometric reagent. As the composition containing the xylenol orange chelates metal ions, a solution of xylenol orange turns from red to a generally blue color.

According to the present invention, the indicator compound may be present in the sealing composition in an amount of at least 0.01 g/1000 g sealing composition, such as at least 0.05 g/1000 g sealing composition, and in some instances, no more than 3 g/1000 g sealing composition, such as no more than 0.3 g/1000 g sealing composition. According to the present invention, the indicator compound may be present in the sealing composition in an amount of 0.01 g/1000 g sealing composition to 3 g/1000 g sealing composition, such as 0.05 g/1000 g sealing composition to 0.3 g/1000 g sealing composition.

According to the present invention, the indicator compound changing color in response to a certain external stimulus provides a benefit when using the sealing composition in that it can serve, for example, as a visual indication that a substrate has been treated with the composition. For example, a sealing composition comprising an indicator that changes color when exposed to a metal ion that is present in the substrate will change color upon complexing with metal ions in that substrate; this allows the user to see that the substrate has been contacted with the composition. Similar benefits can be realized by depositing an alkaline or acid layer on a substrate and contacting the substrate with a composition of the present invention that changes color when exposed to an alkaline or acidic pH.

Optionally, the sealing composition of the present invention may further comprise a nitrogen-containing heterocyclic compound. The nitrogen-containing heterocyclic compound may include cyclic compounds having 1 nitrogen atom, such as pyrroles, and azole compounds having 2 or more nitrogen atoms, such as pyrazoles, imidazoles, triazoles, tetrazoles and pentazoles, 1 nitrogen atom and 1 oxygen atom, such as oxazoles and isoxazoles, or 1 nitrogen atom and 1 sulfur atom, such as thiazoles and isothiazoles. Nonlimiting examples of suitable azole compounds include 2,5-dimercapto-1,3,4-thiadiazole (CAS:1072-71-5), 1H-benzotriazole (CAS: 95-14-7), 1H-1,2,3-triazole (CAS: 288-36-8), 2-amino-5-mercapto-1,3,4-thiadiazole (CAS: 2349-67-9), also named 5-amino-1,3,4-thiadiazole-2-thiol, and 2-amino-1,3,4-thiadiazole (CAS: 4005-51-0). According to the present invention, for example, the azole compound comprises 2,5-dimercapto-1,3,4-thiadiazole. Additionally, according to the present invention, the nitrogen-containing heterocyclic compound may be in the form of a salt, such as a sodium salt.

The nitrogen-containing heterocyclic compound may be present in the sealing composition at a concentration of at least 0.0005 g per liter of composition, such as at least 0.0008 g per liter of composition, such as at least 0.002 g per liter of composition, and in some instances, may be present in the sealing composition in an amount of no more than 3 g per liter of composition, such as no more than 0.2 g per liter of composition, such as no more than 0.1 g per liter of composition. According to the present invention, the nitrogen-containing heterocyclic compound may be present in the sealing composition (if at all) at a concentration of 0.0005 g per liter of composition to 3 g per liter of composition, such as 0.0008 g per liter of composition to 0.2 g per liter of composition, such as 0.002 g per liter of composition to 0.1 g per liter of composition.

As indicated above, the sealing composition of the present invention comprises an aqueous medium as carrier. The aqueous carrier may optionally contain other materials such as at least one organic solvent. Nonlimiting examples of suitable solvents include propylene glycol, ethylene glycol, glycerol, low molecular weight alcohols (i.e., C₁-C₁₂ alcohols), and the like. When present, if at all, the organic solvent may be present in the sealing composition in an amount of at least 1 g solvent per liter of sealing composition, such as at least about 2 g solvent per liter of sealing composition, and in some instances, may be present in an amount of no more than 40 g solvent per liter of sealing composition, such as no more than 20 g solvent per liter of sealing composition. According to the present invention, the organic solvent may be present in the sealing composition, if at all, in an amount of 1 g solvent per liter of sealing composition to 40 g solvent per liter of sealing composition, such as 2 g solvent per liter of sealing composition to 20 g solvent per liter of sealing composition.

According to the present invention, the pH of the sealing composition may be at least 9.5, such as at least 10, such as at least 11, and in some instances may be no higher than 12.5, such as no higher than 12, such as no higher than 11.5. According to the present invention, the pH of the sealing composition may be 9.5 to 12.5, such as 10 to 12, such as 11 to 11.5. The pH of the sealing composition may be adjusted using, for example, any acid and/or base as is necessary. According to the present invention, the pH of the sealing composition may be maintained through the inclusion of an acidic material, including carbon dioxide, water soluble and/or water dispersible acids, such as nitric acid, sulfuric acid, and/or phosphoric acid. According to the present invention, the pH of the sealing composition may be maintained through the inclusion of a basic material, including water soluble and/or water dispersible bases, including carbonates such as Group I carbonates, Group II carbonates, hydroxides such as lithium hydroxide, sodium hydroxide, potassium hydroxide, or ammonium hydroxide, ammonia, and/or amines such as triethylamine, methylethyl amine, or mixtures thereof.

As mentioned above, the sealing composition may comprise a carrier, often an aqueous medium, so that the composition is in the form of a solution or dispersion of the lithium metal cation in the carrier. According to the invention, the solution or dispersion may be brought into contact with the substrate by any of a variety of known techniques, such as dipping or immersion, spraying, intermittent spraying, dipping followed by spraying, spraying followed by dipping, brushing, or roll-coating. According to the invention, the solution or dispersion when applied to the metal substrate may be at a temperature ranging from 40° F. to about 160° F., such as 60° F. to 110° F. For example, the process of contacting the metal substrate with the sealing composition may be carried out at ambient or room temperature. The contact time is often from 1 second to 2 hours, such as 5 minutes to 60 minutes.

According to the present invention, following the contacting with the sealing composition, the substrate optionally may be air dried at room temperature or may be dried with hot air, for example, by using an air knife, by flashing off the water by brief exposure of the substrate to a high temperature, such as by drying the substrate in an oven at 15° C. to 100° C., such as 20° C. to 90° C., or in a heater assembly using, for example, infrared heat, such as for 10 minutes at 70° C., or by passing the substrate between squeegee rolls. According to the present invention, the substrate surface may be partially, or in some instances, completely dried prior to any subsequent contact of the substrate surface with any water, solutions, compositions, or the like. As used herein with respect to a substrate surface, “completely dry” or “completely dried” means there is no moisture on the substrate surface visible to the human eye.

Optionally, according to the present invention, following the contacting with the sealing composition, the substrate optionally is not rinsed or contacted with any aqueous solutions prior to contacting at least a portion of the substrate surface with subsequent treatment compositions to form films, layers, and/or coatings thereon (described below).

Optionally, according to the present invention, following the contacting with the sealing composition, the substrate optionally may be contacted with an aqueous composition, including but not limited to, tap water, deionized water, reverse osmosis (RO) water, and/or any other aqueous composition known to those of skill in the art of substrate treatment. According to the present invention, and as mentioned above, optionally, such contacting with the aqueous composition may occur immediately following contacting with the sealing composition (i.e., the substrate is “wet” when contacted with the aqueous composition), or optionally, as mentioned above, the substrate may be dried according to any of the methods described above prior to contacting with the aqueous composition. Optionally, as mentioned above, the substrate may be rinsed with water, such as tap water, deionized water, or the like, following the contacting with the sealing composition and prior to contacting with the aqueous composition, in which case the substrate may or may not be dried as described above. According to the present invention, such water or aqueous composition may be at a temperature of room temperature (60° F.) to its boiling point, such as 176° F. to 212° F. when used to contact the substrate. The aqueous composition may have a pH of 5 to 7, such as 5.5 to 6.5. According to the present invention, the aqueous composition may have a conductivity of less than 20 μS/cm. According to the present invention, the aqueous composition may comprise a conditioner, including, but not limited to, for example, dextrins, acrylic acids, methacrylic acids and water soluble polymers derived therefrom, lignin sulphonates, acids such as cycloaliphatic or aromatic polycarboxylic acid having from 4 to 6 carboxylic acid groups per molecule or a water soluble salt thereof, hydroxy carboxylic acids, water-soluble phosphoric acids or one or more water-soluble salts of such acid, or combinations thereof. Such conditioners also may include commercial products known to those in the art, including, but not limited to, for example, Anodal® SH-1 and SH-2 (commercially available from Clariant International Ltd., Switzerland), Sandoz Sealing Salts A/S (commercially available from Sanoz Chemicals, Charlotte, N.C.), Henkel VR/6252/1, Henkel VR/6253/1 (commercially available from Henkel Ag & Co. KGaA), Dowfax 2A1 (commercially available from Dow Chemicals, Midland, Mich.), or combinations thereof. According to the present invention, such conditioners may be present, if at all, in the aqueous composition in an amount sufficient to maintain the pH of the aqueous composition at 5 to 7, such as 5.4 to 5.6.

Following contacting with the aqueous composition, if at all, the substrate then optionally may be dried, for example air dried or dried with hot air as described in the preceding paragraph, such that the substrate surface may be partially, or in some instances, completely dried prior to any subsequent contact of the substrate surface with any water, solutions, compositions, or the like.

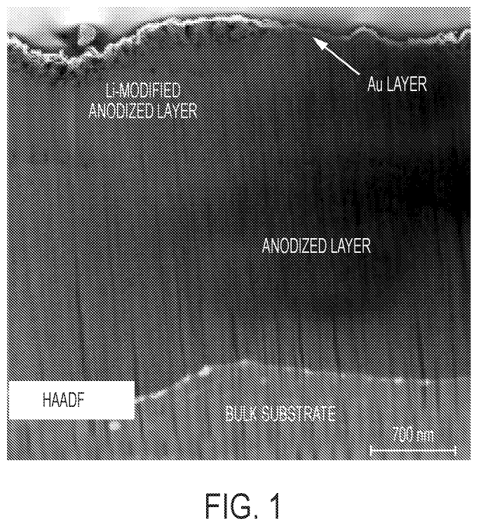

The transmission electron microscope (TEM) image shown in FIG. 1 was captured from a panel prepared using an FEI Helios Nanolab 660 Dual Beam focused ion beam (FIB) using the ‘in situ lift-out’ technique (R. M Langford, “In situ lift-out using a FIB-SEM system”, Micron v. 35, pp. 607-611, 2004). A layer of gold (Au) and then a layer of carbon (C) were deposited using the FIB over the surface of the sample to prevent damage during the subsequent Ga+ ion beam milling. A thin section, roughly 5 microns wide and 5 microns deep, was milled out from the surface of the sample using a 30 kV ion beam and attached to a TEM grid in-situ using a micromanipulator. This section was then thinned further with ion beam until the final thickness was approximately 100 nm. For final cleaning of the surface, an ion beam energy of 2 kV was used. TEM and scanning transmission electron microscopy (STEM) were performed using a FEI Talos F200X field-emission TEM at an accelerating voltage of 200 kV. The magnification of the microscope was calibrated using a cross grating replica standard from Agar Scientific. (Cross Grating Replica, AGS106, diffraction line gratings spacing 462.9 nm, http://www.agarscientific.com/diffraction-grating-replicas.html). HAADF-STEM (high angle annular dark field) images were collected from the sample which results in an image that primarily shows mass contrast approximately proportional to the square of the atomic number of the elements present.

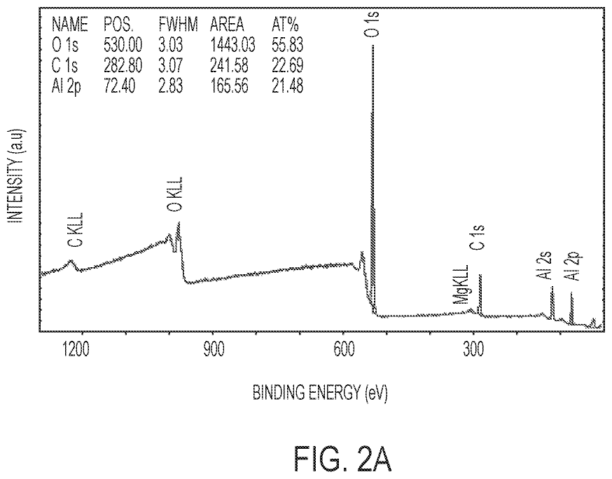

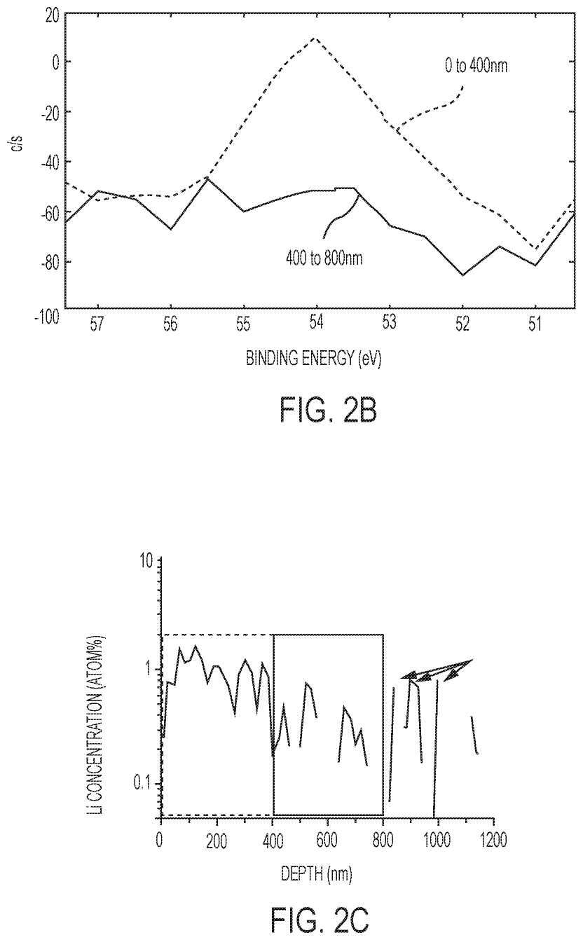

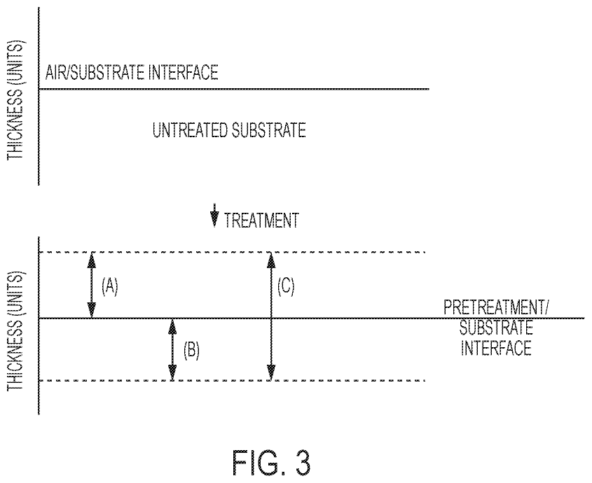

FIG. 2A shows an XPS survey scan of the surface of the substrate shown in FIG. 1 and confirms that no lithium was detected at the substrate surface. The substrate had approximately a 2.2 μm thick oxidized aluminum on alumbinum-copper alloy (as determined by TEM). Lithium was present at low concentrations in the outer 400 nm of the anodized layer with a maximum concentration (1.5 atom %) about 100 nm to 150 nm below the surface. Therefore, according to the present invention, the thickness of the layer formed by the sealing composition may be 5 nm to 550 nm, such as 10 nm to 400 nm, such as 90 nm to 175 nm, such as 100 nm to 150 nm. As used herein, “thickness,” when used with respect to a layer formed by the sealing composition, refers to either (a) a layer formed above the original air/substrate interface, (b) a modified layer formed below the original air/substrate interface, or (c) a combination of (a) and (b), as illustrated in FIG. 3. As used herein, “thickness,” when used with respect to a layer formed by the treatment composition of the present invention, refers to either (a) a layer formed above the original air/substrate interface, (b) a modified layer formed below the pretreatment/substrate interface, or (c) a combination of (a) and (b), as illustrated in FIG. 3. Although modified layer (b) is shown extending to the pretreatment/substrate interface in FIG. 3, an intervening layer may be present between the modified layer (b) and the pretreatment/substrate interface. Likewise, (c), a combination of (a) and (b), is not limited to a continuous layer and may include multiple layers with intervening layers therebetween, and the measurement of the thickness of layer (c) may exclude the intervening layers.

FIG. 2B shows an XPS depth profile of the substrate shown in FIG. 1. XPS data were generated using a Physical Electronics VersaProbe II instrument equipped with a monochromatic Al kα x-ray source (hv=1,486.7 eV) and a concentric hemispherical analyzer. Charge neutralization was performed using both low energy electrons (<5 eV) and argon ions. The binding energy axis was calibrated using sputter cleaned Cu foil (Cu 2p3/2=932.7 eV, Cu 2p3/2=75.1 eV). Peaks were charge referenced to CHx band in the carbon is spectra at 284.8 eV. Measurements were made at a takeoff angle of 45° with respect to the sample surface plane. This resulted in a typical sampling depth of 3-6 nm (95% of the signal originated from this depth or shallower). The analysis size was ˜500 μm in diameter. Quantification was done using instrumental relative sensitivity factors (RSFs) that account for the x-ray cross section and inelastic mean free path of the electrons. Depth profiling was done using a 4 kV Ar+ beam rastered over 2 mm×2 mm area. Sample rotation was used to minimize roughening during milling. The sputtering rate in the Al2O3 layer was 20 nm/min based on the measured thickness (based on TEM) of 2200 nm. Depth profile for the 1^{st} analyses was ˜116 nm increment and total sputter depth was ˜2.2 micron. Depth profile for the 2^{nd} analyses was ˜50 nm increment and total depth was 1000 nm. These data confirm that the highest concentration (1.5 atom %) occurs at approximately 100 nm to approximately 400 nm below the substrate surface.

FIG. 2C shows the summed lithium is spectra of the XPS depth profile of the data shown in FIG. 2B. The upper line is the summed lithium is spectra from air/substrate interface to 400 nm below the interface, and corresponding to the left-hand box in FIG. 2B. This peak is typical of a lithium spectra. The lower line is the summed lithium is spectra of below 400 nm and confirms that lithium was not present below 400 nm. This lower line corresponds to the data shown in the right-hand box of FIG. 2B (i.e., 400 nm to 800 nm).

The TEM images and the XPS depth profiling demonstrate that treatment of anodized panels according to the method of the present invention results in the formation of a lithium-modified anodized layer between the air/substrate surface interface and the anodized layer that is 100 nm to 450 nm below the air/substrate surface interface (see FIG. 2), such as 120 nm to 250 nm.

According to the present invention, prior to anodizing the substrate, at least a portion of the substrate surface may be cleaned and/or deoxidized in order to remove grease, dirt, and/or other extraneous matter. At least a portion of the surface of the substrate may be cleaned by physical and/or chemical means, such as mechanically abrading the surface and/or cleaning/degreasing the surface with commercially available alkaline or acidic cleaning agents that are well known to those skilled in the art. Examples of alkaline cleaners suitable for use in the present invention include Chemkleen™ 166tlP, 166 m/c, 177, 490MX, 2010LP, and Surface Prep 1 (SP1), Ultrax 32, Ultrax 97, Ultrax 29 and 92D, each of which are commercially available from PPG Industries, Inc. (Cleveland, Ohio), and any of the DFM Series, RECC 1001, and 88X1002 cleaners commercially available from PRC-DeSoto International, Sylmar, Calif.), and Turco 4215-NCLT and Ridolene (commercially available from Henkel Technologies, Madison Heights, Mich.). Such cleaners are often preceded or followed by a water rinse, such as with tap water, distilled water, or combinations thereof.

As mentioned above, according to the present invention, prior to anodizing the substrate, at least a portion of the cleaned substrate surface may be deoxidized, mechanically and/or chemically. As used herein, the term “deoxidize” means removal of the oxide layer found on the surface of the substrate in order to promote uniform deposition of the sealing composition, as well as to promote the adhesion of the sealing composition coating to the substrate surface. Suitable deoxidizers will be familiar to those skilled in the art. A typical mechanical deoxidizer may be uniform roughening of the substrate surface, such as by using a scouring or cleaning pad. Typical chemical deoxidizers include, for example, acid-based deoxidizers such as phosphoric acid, nitric acid, fluoroboric acid, sulfuric acid, chromic acid, hydrofluoric acid, and ammonium bifluoride, or Amchem 7/17 deoxidizers (available from Henkel Technologies, Madison Heights, Mich.), OAKITE DEOXIDIZER LNC (commercially available from Chemetall), TURCO DEOXIDIZER 6 (commercially available from Henkel), or combinations thereof. Often, the chemical deoxidizer comprises a carrier, often an aqueous medium, so that the deoxidizer may be in the form of a solution or dispersion in the carrier, in which case the solution or dispersion may be brought into contact with the substrate by any of a variety of known techniques, such as dipping or immersion, spraying, intermittent spraying, dipping followed by spraying, spraying followed by dipping, brushing, or roll-coating. According to the present invention, the skilled artisan will select a temperature range of the solution or dispersion, when applied to the metal substrate, based on etch rates, for example, at a temperature ranging from 50° F. to 150° F. (10° C. to 66° C.), such as from 70° F. to 130° F. (21° C. to 54° C.), such as from 80° F. to 120° F. (27° C. to 49° C.). The contact time may be from 30 seconds to 20 minutes, such as 1 minute to 15 minutes, such as 90 seconds to 12 minutes, such as 3 minutes to 9 minutes.

Following the cleaning and/or deoxidizing step(s), the substrate optionally may be rinsed with tap water, deionized water, and/or an aqueous solution of rinsing agents in order to remove any residue. According to the present invention, the wet substrate surface may be treated with the sealing composition of the present invention (described above), or the substrate may be dried prior to treating the substrate surface, such as air dried, for example, by using an air knife, by flashing off the water by brief exposure of the substrate to a high temperature, such as 15° C. to 100° C., such as 20° C. to 90° C., or in a heater assembly using, for example, infrared heat, such as for 10 minutes at 70° C., or by passing the substrate between squeegee rolls.

It has been surprisingly discovered that the use of the sealing composition of the present invention produces sealed anodized aluminum surfaces of superior quality specifically, contacting an anodized substrate with the lithium-containing sealing composition of the present invention resulted in a treated substrate which had significantly improved corrosion performance compared to a non-anodized substrate that was treated with the lithium seal composition and compared to an anodized panel treated with a hot water immersion. These results were unexpected.

Furthermore, it also has been surprisingly discovered that contacting an anodized substrate with the lithium-containing sealing composition of the present invention followed by immersing the substrate in hot water resulted in a treated substrate of superior quality.

According to the present invention, after the substrate is contacted with the sealing composition of the present invention, a coating composition comprising a film-forming resin may be deposited onto at least a portion of the surface of the substrate that has been contacted with the sealing composition. Any suitable technique may be used to deposit such a coating composition onto the substrate, including, for example, brushing, dipping, flow coating, spraying and the like. In some instances, however, as described in more detail below, such depositing of a coating composition may comprise an electrocoating step wherein an electrodepositable composition is deposited onto a metal substrate by electrodeposition. In certain other instances, as described in more detail below, such depositing of a coating composition comprises a powder coating step. In still other instances, the coating composition may be a liquid coating composition.

According to the present invention, the coating composition may comprise a thermosetting film-forming resin or a thermoplastic film-forming resin. As used herein, the term “film-forming resin” refers to resins that can form a self-supporting continuous film on at least a horizontal surface of a substrate upon removal of any diluents or carriers present in the composition or upon curing at ambient or elevated temperature. Conventional film-forming resins that may be used include, without limitation, those typically used in automotive OEM coating compositions, automotive refinish coating compositions, industrial coating compositions, architectural coating compositions, coil coating compositions, and aerospace coating compositions, among others. As used herein, the term “thermosetting” refers to resins that “set” irreversibly upon curing or crosslinking, wherein the polymer chains of the polymeric components are joined together by covalent bonds. This property is usually associated with a cross-linking reaction of the composition constituents often induced, for example, by heat or radiation. Curing or crosslinking reactions also may be carried out under ambient conditions. Once cured or crosslinked, a thermosetting resin will not melt upon the application of heat and is insoluble in solvents. As used herein, the term “thermoplastic” refers to resins that comprise polymeric components that are not joined by covalent bonds and thereby can undergo liquid flow upon heating and are soluble in solvents.

As previously indicated, according to the present invention, an electrodepositable coating composition comprising a water-dispersible, ionic salt group-containing film-forming resin that may be deposited onto the substrate by an electrocoating step wherein the electrodepositable coating composition is deposited onto the metal substrate by electrodeposition. The ionic salt group-containing film-forming polymer may comprise a cationic salt group containing film-forming polymer for use in a cationic electrodepositable coating composition. As used herein, the term “cationic salt group-containing film-forming polymer” refers to polymers that include at least partially neutralized cationic groups, such as sulfonium groups and ammonium groups, that impart a positive charge. The cationic salt group-containing film-forming polymer may comprise active hydrogen functional groups, including, for example, hydroxyl groups, primary or secondary amine groups, and thiol groups. Cationic salt group-containing film-forming polymers that comprise active hydrogen functional groups may be referred to as active hydrogen-containing, cationic salt group-containing film-forming polymers. Examples of polymers that are suitable for use as the cationic salt group-containing film-forming polymer include, but are not limited to, alkyd polymers, acrylics, polyepoxides, polyamides, polyurethanes, polyureas, polyethers, and polyesters, among others. The cationic salt group-containing film-forming polymer may be present in the cationic electrodepositable coating composition in an amount of 40% to 90% by weight, such as 50% to 80% by weight, such as 60% to 75% by weight, based on the total weight of the resin solids of the electrodepositable coating composition. As used herein, the “resin solids” include the ionic salt group-containing film-forming polymer, curing agent, and any additional water-dispersible non-pigmented component(s) present in the electrodepositable coating composition.

Alternatively, the ionic salt group containing film-forming polymer may comprise an anionic salt group containing film-forming polymer for use in an anionic electrodepositable coating composition. As used herein, the term “anionic salt group containing film-forming polymer” refers to an anionic polymer comprising at least partially neutralized anionic functional groups, such as carboxylic acid and phosphoric acid groups that impart a negative charge. The anionic salt group-containing film-forming polymer may comprise active hydrogen functional groups. Anionic salt group-containing film-forming polymers that comprise active hydrogen functional groups may be referred to as active hydrogen-containing, anionic salt group-containing film-forming polymers. The anionic salt group-containing film-forming polymer may comprise base-solubilized, carboxylic acid group-containing film-forming polymers such as the reaction product or adduct of a drying oil or semi-drying fatty acid ester with a dicarboxylic acid or anhydride; and the reaction product of a fatty acid ester, unsaturated acid or anhydride and any additional unsaturated modifying materials which are further reacted with polyol. Also suitable are the at least partially neutralized interpolymers of hydroxy-alkyl esters of unsaturated carboxylic acids, unsaturated carboxylic acid and at least one other ethylenically unsaturated monomer. Still another suitable anionic electrodepositable resin comprises an alkyd-aminoplast vehicle, i.e., a vehicle containing an alkyd resin and an amine-aldehyde resin. Another suitable anionic electrodepositable resin composition comprises mixed esters of a resinous polyol. Other acid functional polymers may also be used such as phosphatized polyepoxide or phosphatized acrylic polymers. Exemplary phosphatized polyepoxides are disclosed in U.S. Patent Application Publication No. 2009-0045071 at [0004]-[0015] and U.S. patent application Ser. No. 13/232,093 at [0014]-[0040], the cited portions of which being incorporated herein by reference. The anionic salt group-containing film-forming polymer may be present in the anionic electrodepositable coating composition in an amount 50% to 90%, such as 55% to 80%, such as 60% to 75%, based on the total weight of the resin solids of the electrodepositable coating composition.

The electrodepositable coating composition may further comprise a curing agent. The curing agent may react with the reactive groups, such as active hydrogen groups, of the ionic salt group-containing film-forming polymer to effectuate cure of the coating composition to form a coating. Non-limiting examples of suitable curing agents are at least partially blocked polyisocyanates, aminoplast resins and phenoplast resins, such as phenolformaldehyde condensates including allyl ether derivatives thereof. The curing agent may be present in the cationic electrodepositable coating composition in an amount of 10% to 60% by weight, such as 20% to 50% by weight, such as 25% to 40% by weight, based on the total weight of the resin solids of the electrodepositable coating composition. Alternatively, the curing agent may be present in the anionic electrodepositable coating composition in an amount of 10% to 50% by weight, such as 20% to 45% by weight, such as 25% to 40% by weight, based on the total weight of the resin solids of the electrodepositable coating composition.

The electrodepositable coating composition may further comprise other optional ingredients, such as a pigment composition and, if desired, various additives such as fillers, plasticizers, anti-oxidants, biocides, UV light absorbers and stabilizers, hindered amine light stabilizers, defoamers, fungicides, dispersing aids, flow control agents, surfactants, wetting agents, or combinations thereof.

The electrodepositable coating composition may comprise water and/or one or more organic solvent(s). Water can for example be present in amounts of 40% to 90% by weight, such as 50% to 75% by weight, based on total weight of the electrodepositable coating composition. If used, the organic solvents may typically be present in an amount of less than 10% by weight, such as less than 5% by weight, based on total weight of the electrodepositable coating composition. The electrodepositable coating composition may in particular be provided in the form of an aqueous dispersion. The total solids content of the electrodepositable coating composition may be from 1% to 50% by weight, such as 5% to 40% by weight, such as 5% to 20% by weight, based on the total weight of the electrodepositable coating composition. As used herein, “total solids” refers to the non-volatile content of the electrodepositable coating composition, i.e., materials which will not volatilize when heated to 110° C. for 15 minutes.

The cationic electrodepositable coating composition may be deposited upon an electrically conductive substrate by placing the composition in contact with an electrically conductive cathode and an electrically conductive anode, with the surface to be coated being the cathode. Alternatively, the anionic electrodepositable coating composition may be deposited upon an electrically conductive substrate by placing the composition in contact with an electrically conductive cathode and an electrically conductive anode, with the surface to be coated being the anode. An adherent film of the electrodepositable coating composition is deposited in a substantially continuous manner on the cathode or anode, respectively, when a sufficient voltage is impressed between the electrodes. The applied voltage may be varied and can be, for example, as low as one volt to as high as several thousand volts, such as between 50 and 500 volts. Current density is usually between 1.0 ampere and 15 amperes per square foot (10.8 to 161.5 amperes per square meter) and tends to decrease quickly during the electrodeposition process, indicating formation of a continuous self-insulating film.

Once the cationic or anionic electrodepositable coating composition is electrodeposited over at least a portion of the electroconductive substrate, the coated substrate may be heated to a temperature and for a time sufficient to cure the electrodeposited coating on the substrate. For cationic electrodeposition, the coated substrate may be heated to a temperature ranging from 250° F. to 450° F. (121.1° C. to 232.2° C.), such as from 275° F. to 400° F. (135° C. to 204.4° C.), such as from 300° F. to 360° F. (149° C. to 180° C.). For anionic electrodeposition, the coated substrate may be heated to a temperature ranging from 200° F. to 450° F. (93° C. to 232.2° C.), such as from 275° F. to 400° F. (135° C. to 204.4° C.), such as from 300° F. to 360° F. (149° C. to 180° C.), such as 200° F. to 210.2° F. (93° C. to 99° C.). The curing time may be dependent upon the curing temperature as well as other variables, for example, the film thickness of the electrodeposited coating, level and type of catalyst present in the composition and the like. For example, the curing time can range from 10 minutes to 60 minutes, such as 20 to 40 minutes. The thickness of the resultant cured electrodeposited coating may range from 2 to 50 microns.

Alternatively, as mentioned above, according to the present invention, after the substrate has been contacted with the sealing composition of the present invention, a powder coating composition may then be deposited onto at least a portion of the surface of the substrate. As used herein, “powder coating composition” refers to a coating composition which is completely free of water and/or solvent. Accordingly, the powder coating composition disclosed herein is not synonymous to waterborne and/or solvent-borne coating compositions known in the art. According to the present invention, the powder coating composition may comprise (a) a film forming polymer having a reactive functional group; and (b) a curing agent that is reactive with the functional group. Examples of powder coating compositions that may be used in the present invention include the polyester-based ENVIROCRON line of powder coating compositions (commercially available from PPG Industries, Inc.) or epoxy-polyester hybrid powder coating compositions. Alternative examples of powder coating compositions that may be used in the present invention include low temperature cure thermosetting powder coating compositions comprising (a) at least one tertiary aminourea compound, at least one tertiary aminourethane compound, or mixtures thereof, and (b) at least one film-forming epoxy-containing resin and/or at least one siloxane-containing resin (such as those described in U.S. Pat. No. 7,470,752, assigned to PPG Industries, Inc. and incorporated herein by reference); curable powder coating compositions generally comprising (a) at least one tertiary aminourea compound, at least one tertiary aminourethane compound, or mixtures thereof, and (b) at least one film-forming epoxy-containing resin and/or at least one siloxane-containing resin (such as those described in U.S. Pat. No. 7,432,333, assigned to PPG Industries, Inc. and incorporated herein by reference); and those comprising a solid particulate mixture of a reactive group-containing polymer having a T_{g} of at least 30° C. (such as those described in U.S. Pat. No. 6,797,387, assigned to PPG Industries, Inc. and incorporated herein by reference). After deposition of the powder coating composition, the coating is often heated to cure the deposited composition. The heating or curing operation is often carried out at a temperature in the range of from 150° C. to 200° C., such as from 170° C. to 190° C., for a period of time ranging from 10 to 20 minutes. According to the invention, the thickness of the resultant film is from 50 microns to 125 microns.

As mentioned above, according to the present invention after the substrate has been contacted with the sealing composition of the present invention, a liquid coating composition may then be applied or deposited into at least a portion of the substrate surface. As used herein, “liquid coating composition” refers to a coating composition which contains a portion of water and/or solvent. Accordingly, the liquid coating composition disclosed herein is synonymous to waterborne and/or solventborne coating compositions known in the art. According to the present invention, the liquid coating composition may comprise, for example, (a) a film forming polymer having a reactive functional group; and (b) a curing agent that is reactive with the functional group. In other examples, the liquid coating may contain a film forming polymer that may react with oxygen in the air or coalesce into a film with the evaporation of water and/or solvents. These film forming mechanisms may require or be accelerated by the application of heat or some type of radiation such as Ultraviolet or Infrared. Examples of liquid coating compositions that may be used in the present invention include the SPECTRACRON® line of solvent based coating compositions, the AQUACRON® line of water based coating compositions, and the RAYCRON® line of UV cured coatings (all commercially available from PPG Industries, Inc.). Suitable film forming polymers that may be used in the liquid coating composition of the present invention may comprise a (poly)ester, an alkyd, a (poly)urethane, an isocyanurate, a (poly)urea, a (poly)epoxy, an anhydride, an acrylic, a (poly)ether, a (poly)sulfide, a (poly)amine, a (poly)amide, (poly)vinyl chloride, (poly)olefin, (poly)vinylidene fluoride, (poly)siloxane, or combinations thereof.

According to the present invention, the substrate that has been contacted with the sealing composition may also be contacted with a primer composition and/or a topcoat composition. The primer coat may be, for examples, chromate-based primers and advanced performance topcoats. According to the present invention, the primer coat can be a conventional chromate based primer coat, such as those available from PPG Industries, Inc. (product code 44GN072), or a chrome-free primer such as those available from PPG (DESOPRIME CA7502, DESOPRIME CA7521, Deft 02GN083, Deft 02GN084). Alternately, the primer coat can be a chromate-free primer coat, such as the coating compositions described in U.S. patent application Ser. No. 10/758,973, titled “CORROSION RESISTANT COATINGS CONTAINING CARBON”, and U.S. patent application Ser. Nos. 10/758,972, and 10/758,972, both titled “CORROSION RESISTANT COATINGS”, all of which are incorporated herein by reference, and other chrome-free primers that are known in the art, and which can pass the military requirement of MIL-PRF-85582 Class N or MIL-PRF-23377 Class N may also be used with the current invention.

As mentioned above, the substrate of the present invention also may comprise a topcoat. As used herein, the term “topcoat” refers to a mixture of binder(s) which can be an organic or inorganic based polymer or a blend of polymers, typically at least one pigment, can optionally contain at least one solvent or mixture of solvents, and can optionally contain at least one curing agent. A topcoat is typically the coating layer in a single or multi-layer coating system whose outer surface is exposed to the atmosphere or environment, and its inner surface is in contact with another coating layer or polymeric substrate. Examples of suitable topcoats include those conforming to MIL-PRF-85285D, such as those available from PPG (Deft 03W127A and Deft 03GY292). According to the present invention, the topcoat may be an advanced performance topcoat, such as those available from PPG (Defthane® ELT™ 99GY001 and 99W009). However, other topcoats and advanced performance topcoats can be used in the present invention as will be understood by those of skill in the art with reference to this disclosure.

According to the present invention, the metal substrate also may comprise a self-priming topcoat, or an enhanced self-priming topcoat. The term “self-priming topcoat”, also referred to as a “direct to substrate” or “direct to metal” coating, refers to a mixture of a binder(s), which can be an organic or inorganic based polymer or blend of polymers, typically at least one pigment, can optionally contain at least one solvent or mixture of solvents, and can optionally contain at least one curing agent. The term “enhanced self-priming topcoat”, also referred to as an “enhanced direct to substrate coating” refers to a mixture of functionalized fluorinated binders, such as a fluoroethylene-alkyl vinyl ether in whole or in part with other binder(s), which can be an organic or inorganic based polymer or blend of polymers, typically at least one pigment, can optionally contain at least one solvent or mixture of solvents, and can optionally contain at least one curing agent. Examples of self-priming topcoats include those that conform to TT-P-2756A. Examples of self-priming topcoats include those available from PPG (03W169 and 03GY369), and examples of enhanced self-priming topcoats include Defthane® ELT′/ESPT and product code number 97GY121, available from PPG. However, other self-priming topcoats and enhanced self-priming topcoats can be used in the coating system according to the present invention as will be understood by those of skill in the art with reference to this disclosure.

According to the present invention, the self-priming topcoat and enhanced self-priming topcoat may be applied directly to the sealed substrate. The self-priming topcoat and enhanced self-priming topcoat can optionally be applied to an organic or inorganic polymeric coating, such as a primer or paint film. The self-priming topcoat layer and enhanced self-priming topcoat is typically the coating layer in a single or multi-layer coating system where the outer surface of the coating is exposed to the atmosphere or environment, and the inner surface of the coating is typically in contact with the substrate or optional polymer coating or primer.

According to the present invention, the topcoat, self-priming topcoat, and enhanced self-priming topcoat can be applied to the sealed substrate, in either a wet or “not fully cured” condition that dries or cures over time, that is, solvent evaporates and/or there is a chemical reaction. The coatings can dry or cure either naturally or by accelerated means for example, an ultraviolet light cured system to form a film or “cured” paint. The coatings can also be applied in a semi or fully cured state, such as an adhesive.

In addition, a colorant and, if desired, various additives such as surfactants, wetting agents or catalyst can be included in the coating composition (electrodepositable, powder, or liquid). As used herein, the term “colorant” means any substance that imparts color and/or other opacity and/or other visual effect to the composition. Example colorants include pigments, dyes and tints, such as those used in the paint industry and/or listed in the Dry Color Manufacturers Association (DCMA), as well as special effect compositions. In general, the colorant can be present in the coating composition in any amount sufficient to impart the desired visual and/or color effect. The colorant may comprise from 1 to 65 weight percent, such as from 3 to 40 weight percent or 5 to 35 weight percent, with weight percent based on the total weight of the composition.

For purposes of the following detailed description, it is to be understood that the invention may assume various alternative variations and step sequences, except where expressly specified to the contrary. Moreover, other than in any operating examples, or where otherwise indicated, all numbers such as those expressing values, amounts, percentages, ranges, subranges and fractions may be read as if prefaced by the word “about,” even if the term does not expressly appear. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques. Where a closed or open-ended numerical range is described herein, all numbers, values, amounts, percentages, subranges and fractions within or encompassed by the numerical range are to be considered as being specifically included in and belonging to the original disclosure of this application as if these numbers, values, amounts, percentages, subranges and fractions had been explicitly written out in their entirety.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

As used herein, unless indicated otherwise, a plural term can encompass its singular counterpart and vice versa, unless indicated otherwise. For example, although reference is made herein to “an” anodizing composition, “a” sealing composition, and “a” lithium salt, a combination (i.e., a plurality) of these components can be used. In addition, in this application, the use of “or” means “and/or” unless specifically stated otherwise, even though “and/or” may be explicitly used in certain instances.

As used herein, “including,” “containing” and like terms are understood in the context of this application to be synonymous with “comprising” and are therefore open-ended and do not exclude the presence of additional undescribed and/or unrecited elements, materials, ingredients and/or method steps. As used herein, “consisting of” is understood in the context of this application to exclude the presence of any unspecified element, ingredient and/or method step. As used herein, “consisting essentially of” is understood in the context of this application to include the specified elements, materials, ingredients and/or method steps “and those that do not materially affect the basic and novel characteristic(s)” of what is being described.

As used herein, the terms “on,” “onto,” “applied on,” “applied onto,” “formed on,” “deposited on,” “deposited onto,” mean formed, overlaid, deposited, and/or provided on but not necessarily in contact with the surface. For example, a coating layer “formed over” a substrate does not preclude the presence of one or more other intervening coating layers of the same or different composition located between the formed coating layer and the substrate.

Unless otherwise disclosed herein, the term “substantially free,” when used with respect to the absence of a particular material, means that such material, if present at all in a composition, a bath containing the composition, and/or layers formed from and comprising the composition, only is present in a trace amount of 5 ppm or less based on a total weight of the composition, bath and/or layer(s), as the case may be. Unless otherwise disclosed herein, the term “essentially free,” when used with respect to the absence of a particular material, means that such material, if present at all in a composition, a bath containing the composition, and/or layers formed from and comprising the composition, only is present in a trace amount of 1 ppm or less based on a total weight of the composition, bath and/or layer(s), as the case may be. Unless otherwise disclosed herein, the term “completely free,” when used with respect to the absence of a particular material, means that such material, if present at all in a composition, a bath containing the composition, and/or layers formed from and comprising the composition, is absent from the composition, the bath containing the composition, and/or layers formed from and comprising same (i.e., the composition, bath containing the composition, and/or layers formed from and comprising the composition contain 0 ppm of such material). When a composition, bath containing a composition, and/or a layer(s) formed from and comprising the same is substantially free, essentially free, or completely free of a particular material, this means that such material is excluded therefrom, except that the material may be present as a result of, for example, carry-over from prior treatment baths in the processing line, municipal water sources, substrate(s), and/or dissolution of equipment.

As used herein, a “salt” refers to an ionic compound made up of metal cations and non-metallic anions and having an overall electrical charge of zero. Salts may be hydrated or anhydrous.

As used herein, “aqueous composition” refers to a solution or dispersion in a medium that comprises predominantly water. For example, the aqueous medium may comprise water in an amount of more than 50 wt. %, or more than 70 wt. % or more than 80 wt. % or more than 90 wt. % or more than 95 wt. %, based on the total weight of the medium. The aqueous medium may for example consist substantially of water.

As used herein, a “sealing composition” refers to a composition, e.g. a solution or dispersion, that affects a substrate surface or a material deposited onto a substrate surface in such a way as to alter the physical and/or chemical properties of the substrate surface (e.g., the composition affords corrosion protection).

As used herein, the term “oxidizing agent,” when used with respect to a component of the sealing composition, refers to a chemical which is capable of oxidizing at least one of: a metal present in the substrate which is contacted by the sealing composition and/or a metal-complexing agent present in the sealing composition. As used herein with respect to “oxidizing agent,” the phrase “capable of oxidizing” means capable of removing electrons from an atom or a molecule present in the substrate or the sealing composition, as the case may be, thereby decreasing the number of electrons.

As used herein, the term “Group IA metal” refers to an element that is in Group IA of the CAS version of the Periodic Table of the Elements as is shown, for example, in the Handbook of Chemistry and Physics, 63^{rd} edition (1983), corresponding to Group 1 in the actual IUPAC numbering.

As used herein, the term “Group IA metal compound” refers to compounds that include at least one element that is in Group IA of the CAS version of the Periodic Table of the Elements.

As used herein, the term “Group VB metal” refers to an element that is in group VB of the CAS version of the Periodic Table of the Elements as is shown, for example, in the Handbook of Chemistry and Physics, 63^{rd} edition (1983), corresponding to Group 5 in the actual IUPAC numbering.

As used herein, the term “Group VB metal compound” refers to compounds that include at least one element that is in Group VB of the CAS version of the Periodic Table of the Elements.

As used herein, the term “Group VIB metal” refers to an element that is in group VIB of the CAS version of the Periodic Table of the Elements as is shown, for example, in the Handbook of Chemistry and Physics, 63^{rd} edition (1983), corresponding to Group 6 in the actual IUPAC numbering.

As used herein, the term “Group VIB metal compound” refers to compounds that include at least one element that is in Group VIB of the CAS version of the Periodic Table of the Elements.

As used herein, the term “halogen” refers to any of the elements fluorine, chlorine, bromine, iodine, and astatine of the CAS version of the Periodic Table of the Elements, corresponding to Group VILA of the periodic table.

As used herein, the term “halide” refers to compounds that include at least one halogen.

As used herein, the term “aluminum,” when used in reference to a substrate, refers to substrates made of or comprising aluminum and/or aluminum alloy, and clad aluminum substrates.

Pitting corrosion is the localized formation of corrosion by which cavities or holes are produced in a substrate. The term “pit,” as used herein, refers to such cavities or holes resulting from pitting corrosion and is characterized by (1) a rounded, elongated or irregular appearance when viewed normal to the test panel surface, (2) a “comet-tail”, a line, or a “halo” (i.e., a surface discoloration) emanating from the pitting cavity, and (3) the presence of corrosion byproduct (e.g., white, grayish or black granular, powdery or amorphous material) inside or immediately around the pit. An observed surface cavity or hole must exhibit at least two of the above characteristics to be considered a corrosion pit. Surface cavities or holes that exhibit only one of these characteristics may require additional analysis before being classified as a corrosion pit. Visual inspection using a microscope with 10× magnification is used to determine the presence of corrosion byproducts when corrosion byproducts are not visible with the unaided eye. “Dark area” corrosion, as used herein, refers to uniform corrosion that occurs over a given area of a substrate surface.

Unless otherwise disclosed herein, as used herein, the terms “total composition weight”, “total weight of a composition” or similar terms refer to the total weight of all ingredients being present in the respective composition including any carriers and solvents.

In view of the foregoing description the present invention thus relates in particular, without being limited thereto, to the following Aspects 1-22:

### ASPECTS

1. A method of treating a substrate comprising: contacting at least a portion of the substrate surface with a sealing composition having a pH of 9.5 to 12.5 and comprising a lithium metal cation; wherein at least a portion of the substrate surface is anodized prior to the contacting.

2. The method of Aspect 1, wherein the lithium metal cation is present as a lithium salt.

3. The method of Aspect 1 or 2, wherein the lithium metal cation is present in the sealing composition in an amount of 5 ppm to 5500 ppm (as metal cation) based on total weight of the sealing composition.

4. The method of any of the preceding Aspects, wherein the sealing composition further comprises a carbonate anion, a hydroxide anion, or combinations thereof.

5. The method of any of the preceding Aspects, wherein the sealing composition further comprises a of a Group IA metal cation other than lithium, a Group VB metal cation, a Group VIB metal cation, a corrosion inhibitor, an indicator compound, or combinations thereof.

6. The method of any of the preceding Aspects, wherein the sealing composition is substantially free of fluoride, cobalt, vanadium, and/or calcium.

7. The method of any of the preceding Aspects, further comprising contacting at least a portion of the substrate surface with an aqueous composition having a temperature above 90° C.; wherein the contacting with the aqueous composition occurs after the contacting with the sealing composition.

8. The method of Aspect 7, wherein the contacting with the aqueous composition is for 5 minutes to 45 minutes.

9. The method of Aspect 7 or 8, wherein the aqueous composition has a pH of 5 to 7.

10. The method of any of Aspects 7 to 9, wherein the aqueous composition has a conductivity of less than 20 μS/cm.

11. The method of any of the preceding Aspects, wherein the substrate surface is not dried following the contacting with the sealing composition and prior to contacting with a subsequent composition.

12. The method of any of Aspects 1 to 10, wherein the substrate surface is dried following the contacting with the sealing composition and prior to contacting with a subsequent composition.

13. The method of any of the preceding Aspects, wherein the substrate comprises aluminum, aluminum alloys, or combinations thereof.

14. The method of any of the preceding Aspects, wherein the substrate comprises an aluminum alloy comprising copper in an amount of 1 percent by weight to 10 percent by weight.

15. A substrate obtainable by the method of any of the preceding Aspects.

16. A system for treating a metal substrate comprising:

a sealing composition having a pH of 9.5 to 12.5 and comprising a lithium metal cation; and

an aqueous composition comprising a conditioner;

wherein at least a portion of a surface of the substrate is anodized.

17. The system according to Aspect 16, wherein the aqueous composition is for contacting at least a portion of the surface following contacting with the sealing composition.

18. A substrate obtainable by treatment with the system of Aspect 16 or 17.

19. The substrate according to Aspect 15 or 18, wherein substrate treated with the sealing composition has at least a 50% reduction in the number of pits on the substrate surface compared to a substrate not treated with the sealing composition following 3 day exposure in neutral salt spray cabinet operated according to ASTM B117.

20. The substrate according to Aspect 15 or 18, wherein the substrate treated with the sealing composition is devoid of dark areas.

21. The substrate according to any of Aspects 15 or 18 to 20, further comprising a primer layer.

22. The substrate according to any of Aspects 15 or 18 to 21, further comprising a topcoat layer.

Whereas particular features of the present invention have been described above for purposes of illustration, it will be evident to those skilled in the art that numerous variations of the details of the coating composition, coating, and methods disclosed herein may be made without departing from the scope in the appended claims.

Illustrating the invention are the following examples that are not to be considered as limiting the invention to their details. All parts and percentages in the examples, as well as throughout the specification, are by weight unless otherwise indicated.

### EXAMPLES

### Example 1

Example A—Cleaner Composition: The ingredients used to prepare a solution of cleaner Example A are provided in Table 2. Sodium hydroxide and sodium phosphate were completely dissolved in deionized water under mild mechanical agitation using a stir plate (VWR, 7×7 CER HOT/STIR). Next, dissolved, the PVP was stirred in until dissolved, and then Allantoin was added and stirred until dissolved, and then the DMTD was added and stirred until dissolved. After the DMTD was completely dissolved, Carbowet GA100 was stirred in under mild mechanical agitation as above.

TABLE 2
Cleaner Composition (Example A)

| INGREDIENTS | % BY WEIGHT |
|---|---|
| sodium hydroxide pellets, 98% | 1.6 |
| sodium phosphate dodecahydrate, 97% | 6.3 |
| polyvinylpyrrolidone (PVP), 8000 m.w. | 0.02 |
| Allantoin, 98% | 0.03 |
| 2,5-dimercapto-1,3,4-thiadiazole(DMTD), 98% | 1.00 |
| Carbowet GA100 | 4.1 |
| deionized water | 98.7 |

Example B—Lithium Sealing Composition: The sealing solution of Example B was prepared by dissolving 3.07 g of lithium carbonate in 1,996.93 g of deionized water under mild agitation using the stir plate as described above to result in a lithium carbonate concentration of 0.015% by weight, based on the total weight of the composition, and having a pH of 11.2 to 11.3.

Comparative Example (Lithium Seal Composition Only): Aluminum 2024T3 bare substrate measuring 3″×5″×0.032″ was hand-wiped with methyl ethyl ketone (100%) and a disposable cloth and allowed to air dry prior to chemical cleaning. The panel was immersed in the cleaner solution of Example A for 3.5 minutes at ambient temperature with intermittent agitation. The panel was then immersed in two subsequent deionized water rinses for two minutes each, both at ambient temperature with intermittent agitation. After the second rinse, the panel received a cascading deionized water rinse for 10 seconds. The panel was then immersed in the seal solution of Example G for 2 minutes at ambient temperature with intermittent agitation. The panel was air dried at ambient conditions overnight before testing.

The panel was placed in a 7 day exposure in neutral salt spray cabinet operated according to ASTM B117. Corrosion performance was evaluated by counting the number of pits visible to the naked eye on the panels. Data are reported in Table 3.

Experimental Example (Anodized Panel+Lithium Seal Composition): A 3″×10″×0.032″ panel of Al 2024-T3 was solvent wiped on both sides with Methyl Ethyl Ketone using a lint-free paper towel until the surface was visually free from grease and oil. The panel was then immersed in a bath containing Turco 4215 NCLT cleaner (prepared according to manufacturer's instructions) (available from Telford Industries, Kewdale, Western Australia) for 10 minutes. Next, the panel was rinsed using a de-ionized water spray rinse for two minutes, followed by a de-ionized water immersion rinse for two minutes. The panel was then deoxidized using Amchem 7/17 deoxidizer (prepared in accordance with the manufacturer's instructions) (available from Henkel Technologies, Madison Heights, Mich.) for five minutes. Next, the panel was rinsed using a spray rinse for two minutes, followed by a second immersion rinse for two minutes. The panel was then immersed in a proprietary anodizing tank, and anodized for thirty minutes. The panel was then immersed in de-ionized water for two minutes, followed by a second de-ionized water rinse for two minutes. The metal substrate was then immersed in the sealing composition of Example G, which was prepared using the ingredients shown in Table 1 by dissolving lithium carbonate in deionized water under mild agitation using a stir plate. The sealing composition was heated to 110° F. for ten minutes. The panel was allowed to air dry at ambient conditions prior to testing.

The panel was placed in a 7 day exposure in neutral salt spray cabinet operated according to ASTM B117. Corrosion performance was evaluated using the rating scale shown in Table 3. Data are reported in Table 4.

TABLE 3
Rating Scale for Salt Spray

| Rating | Description |
|---|---|
| 10 | identical to how they went in to test/no corrosion |
| 9 | passes with no “countable” pits (if there is a pit, it's |
| | either from an edge, scratch, pre-existing, etc.) |
| 8 | ≤five pits with corrosion salt tails |
| 7 | ≥5 pits with tails and ≤15 pits total |
| 6 | >15 pits total and ≤40 pits total |
| 5 | 30% surface corrosion |
| 4 | 50% surface corrosion |
| 3 | 70% surface corrosion |
| 2 | 85% surface corrosion |
| 1 | 100% surface corrosion |

TABLE 4
Corrosion performance (Example 1)

| | | | | Neutral |
|---|---|---|---|---|
| | | Conversion | Sealing | Salt |
| | Clean/Deox | Composition | Composition | Spray |
| Comparative | Example A | None | Example B | 5 (rating) |
| Experimental | Turco/Anchem | Sulfuric Acid | Example B | 8 (rating) |
| | | Anodize | | |

The data shown in Table 4 demonstrate that contacting an anodized substrate with the lithium-containing sealing composition of the present invention resulted in a treated substrate which had a salt spray rating of 8 following 7 day exposure in neutral salt spray cabinet operated according to ASTM B117, and the anodized substrate with the lithium-containing seal demonstrated significantly improved corrosion resistance compared to a non-anodized panel that was treated with lithium seal composition.

### Example 2

Seventy-six (76) 120×80×0.8 mm panels of 2024T3 were cleaned by immersion in an aqueous alkaline solution containing 15 g/L Chemkleen 190 and 1 g/L Chemkleen 171 (available from PPG, Marly, France), having a pH 11, at a temperature of 60° C. for five minutes. Next, panels were rinsed with deionized water at 35° C. for 5 minutes. Panels were then etched at 50° C. for approximately ten minutes by immersion into a solution containing 60% volume of SOCOSURF A1858 and 10% volume A1806 (available from Socomore, Fort Worth, Tex.) with the balance being deionized water. Panels were rinsed with deionized water at room temperature (25° C.) for 5 minutes.

The cleaned panels were then immersed in an anodizing bath containing 80 g/L of sulfuric acid and 40 g/L of tartaric acid, the bath having a temperature of 37° C. and a voltage of 14+/−1 V, with the current density being in the range 0.6-0.8 A/dm², for 25 minutes to achieve an oxide layer having a thickness of from 2 to 5 microns.

Next, some of the panels were immersed in an alkaline sealing composition bath containing between 0.1% and 1% by weight of Li₂CO₃, based on the total weight of the sealing composition, prepared by adding Li₂CO₃ to deionized water and stirring until dissolved (as detailed in Tables 5 to 8 below). The temperature of the bath was varied from 10° C. to 70° C. and immersion time was varied from 20 to 60 minutes (see Tables 5 to 8 below). The panel was then allowed to dry in a clean environment at room temperature (23° C.) for 10 minutes.

Once dried, some of the panels were then immersed in an aqueous bath having a temperature of from 80° C. to boiling for between 10 to 60 minutes (as detailed in Tables 5, 7, and 8 below). The boiling water had a temperature above 90° C., a pH of between 5.5 and 6.5 and a conductivity below 20 μS/cm.

Comparative panels were cleaned as described above and then were immersed in the aqueous bath described in the preceding paragraph.

Corrosion performance was evaluated according to ISO9227. Pits were counted and are reported as the average of four panels per run.

TABLE 5
Corrosion Performance (Example 2)

| Example | | Aqueous | Neutral Salt spray* | | | |
|---|---|---|---|---|---|---|
| Number | Sealing Composition | Composition | 96 h | 168 h | 500 h | 750 h |
| Comparative | N/A | Boiling water | 0 pits | Dark | — | — |
| | | (1 hr.) | | area | | |
| Experimental | 0.15% Li₂CO₃, 20 | N/A | 18 pits | 17 pits | — | — |
| | minutes, ambient | | | | | |
| | temperature | | | | | |
| Experimental | 0.15% Li₂CO₃, 20 | Boiling water | 0 pits | 0 pits | 0 pits | 0 pits |
| | minutes, ambient | (30 minutes) | | | | |
| | temperature | | | | | |

*Results are reported as the average number of pits counted on 2 panels

The results shown in Table 5 demonstrate that the combination of treating a substrate surface with the lithium-containing sealing composition of the present invention and treating the sealed substrate with boiling water reduced the number of pits on the substrate surface compared to a substrate that was not treated with the sealing composition or not treated with boiling water following application of the sealing composition.

TABLE 6
Effect of Temperature/Time of Lithium
Seal Composition (Example 2)

| Sealing Composition (0.15% | 168 hr. Neutral Salt |
|---|---|
| Li₂CO₃) | spray results*; ** |

| Time | Temperature | # Pits (average of 2 |
|---|---|---|
| (min) | (° C.) | panels) |
| 30 | 20 | 18 |
| 60 | | 12.5 |
| 30 | 40 | 12.5 |
| 60 | | 6.5 |
| 30 | 50 | 5 |
| 60 | | 1.5 |
| 30 | 70 | 2.5 |
| 60 | | 0 |

| | |
|---|---|
| No sealing composition | Dark area |

The panels reported in Table 6 did not receive immersion in the aqueous medium following treatment with the sealing composition. The results shown in Table 6 demonstrate that improved corrosion performance was dependent on the time of immersion in the lithium sealing composition and the temperature of the lithium seal composition. Specifically, the lowest number of pits were found on panels immersed in the lithium seal composition for 30 minutes to 60 minutes at a temperature of 50C to 70C.

TABLE 7
Effect of Temperature, Time and Concentration
of the Lithium Seal Composition (Example 2)

| Sealing Composition | | | | | NSS - (# Pits) | | |
|---|---|---|---|---|---|---|---|
| | | Concentration | Aqueous composition | | (average of 2 panels) | | |
| Temperature | Time | (% Li₂CO₃) | Temperature | Time | 168 h | 500 h | 750 h |
| 10° C. | 20 min | 0.15% | 90° C. | 30 min | 0 | 0 | 0.5 |
| 15° C. | | | | | 0 | 0 | 0 |
| 20° C. | | | | | 0 | 0 | 0.5 |
| 25° C. | | | | | 0 | 0 | 0 |
| 35° C. | | | | | 0 | 0 | 0.5 |
| 40° C. | | | | | 0 | 0 | 1.5 |
| 50° C. | | | | | 0.5 | 0.5 | 1 |
| 25° C. | 5 min | | | | 1 | 1 | 3 |
| | 10 min | | | | 1.5 | 1.5 | 6 |
| | 20 min | | | | 0.5 | 0.5 | 0.5 |
| | 30 min | | | | 0 | 0 | 0 |
| | 20 min | 0.1% | | | 0 | 0 | 0.5 |
| | | 0.5% | | | 0 | 0 | 1.5 |
| | | 1.0% | | | >50 | >50 | >50 |

These data demonstrate the interrelationship of immersion time, bath temperature, and concentration of the lithium-containing sealing composition. The results shown in Table 7 demonstrate that immersion of panels into the sealing composition of the present invention maintained at a temperature of 10° C. to 50° C. had no influence on the corrosion performance when followed by a water soak at 90° C. At 25° C., a minimum of 20 minutes immersion in the sealing composition was required for corrosion performance. A 1% lithium sealing composition provided an unacceptable level of pitting, while the 0.1% and 0.5% compositions were acceptable.

TABLE 8
Effect of Temperature, Time and Concentration of the Aqueous Composition (Example 2)

| Sealing Composition | | | | | NSS Results | | |
|---|---|---|---|---|---|---|---|
| | | Concentration | Aqueous Composition | | (# Pits, average of 2 panels) ** | | |
| Temperature | Time | (% Li₂CO₃) | Temperature | Time | 168 h | 500 h | 750 h |
| 25° C. | 20 min | 0.15% | 80° C. | 30 min | 0.5 | 1.5 | 1.5 |
| | | | 85° C. | | .5 | 0.5 | 7 |
| | | | 90° C. | | 0 | 0 | 1.5 |
| | | | 95° C. | | 0 | 0.5 | 0.5 |
| | | | 100° C. | | 0 | 2 | 3.5 |
| | | | 80° C. | 10 min | 0 | 3 | 28 |
| | | | | 20 min | 2 | 2.5 | 17 |
| | | | | 40 min | 0 | 0.5 | 23.5 |
| | | | 90° C. | 10 min | 1.5 | 2 | 11.5 |
| | | | | 20 min | 0 | 0 | 0.5 |
| | | | | 40 min | 0 | 0 | 0 |
| | | | 100° C. | 10 min | 0 | 0 | 0 |
| | | | | 20 min | 0 | 0 | 0 |
| | | | | 40 min | 0 | 0 | 2.5 |

| | | | | | |
|---|---|---|---|---|---|
| No lithium seal | 100° C. | 60 min | Dark | — | — |
| | | | area | | |

The results shown in Table 8 demonstrate that optimal results were achieved when the aqueous rinse was maintained at a temperature of at least 90° C. and panels were immersed for 20 minutes or more. At 30 minutes, the time of immersion and temperature of the aqueous bath did not affect performance.

### Example 3

First, 2024T3 rolled aluminum panels underwent TSA processing according to Airbus AIPS 02-01-003 standard at Valence-Coast Plating, Garden Calif., USA. Test panels were 10″×4″.

The anodized panels were then immersed in either an alkaline solution or an alkaline-transition metal solution containing 1500 ppm of Li₂CO₃+176 ppm Na₂MoO₃.2H₂O or 1500 ppm Li₂CO₃+176 ppm NaVO₃. The temperature of the bath was 120° F., with an immersion time of 10 minutes. The panels were allowed to dry in a clean environment at room temperature for 10 minutes.

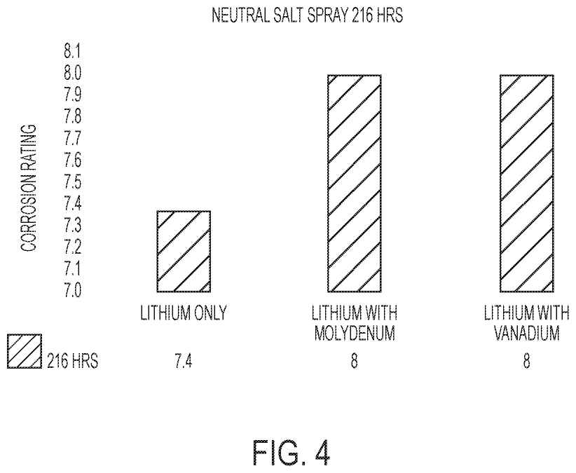

The results shown in FIG. 4 demonstrate that inclusion of either Group VB or Group VIB metal cations in the sealing composition led to an improved corrosion performance compared to sealing composition that did not include the Group VB or Group VIB metal cations.

We claim:

1. A method of treating a substrate comprising:
contacting at least a portion of the substrate surface with a sealing composition having a pH of 9.5 to 12.5 and comprising a lithium metal cation; wherein at least a portion of the substrate surface is anodized prior to the contacting.

2. The method of claim 1, further comprising contacting at least a portion of the substrate surface with an aqueous composition having a temperature above 90° C.; wherein the contacting with the aqueous composition occurs after the contacting with the sealing composition.

3. The method of claim 2, wherein the contacting with the aqueous solution is for 5 minutes to 45 minutes.

4. The method of claim 2, wherein the aqueous composition has a pH of 5 to 7.

5. The method of claim 2, wherein the aqueous composition has a conductivity of less than 20 μS/cm.

6. The method of claim 1, wherein the lithium metal cation is present as a lithium salt.

7. The method of claim 1, wherein the lithium metal cation is present in the sealing composition in an amount of 5 ppm to 5500 ppm (as metal cation) based on total weight of the sealing composition.

8. The method of claim 1, wherein the sealing composition further comprises a carbonate anion, a hydroxide anion, or combinations thereof.

9. The method of claim 1, wherein the sealing composition further comprises a Group IA metal cation other than lithium, a Group VB metal cation, a Group VIB metal cation, a corrosion inhibitor, an indicator compound, or combinations thereof.

10. The method of claim 1, wherein the sealing composition is substantially free of fluoride.

11. The method of claim 1, wherein the sealing composition is substantially free of cobalt.

12. The method of claim 1, wherein the substrate surface is not dried following the contacting with the sealing composition and prior to contacting with a subsequent composition.

13. The method of claim 1, wherein the substrate surface is dried following the contacting with the sealing composition and prior to contacting with a subsequent composition.

14. A substrate treated by the method of claim 1.

15. The substrate of claim 14, wherein the substrate comprises aluminum, aluminum alloys, or combinations thereof.

16. The substrate of claim 1, wherein the substrate comprises an aluminum alloy comprising copper in an amount of 1 percent by weight to 10 percent by weight.

17. The substrate according to claim 14, wherein substrate treated with the sealing composition has at least a 50% reduction in the number of pits on the substrate surface compared to a substrate not treated with the sealing composition following 3 day exposure in neutral salt spray cabinet operated according to ASTM B117.

18. The substrate according to claim 14, wherein the substrate treated with the sealing composition is devoid of dark areas.

19. The substrate according to claim 14, further comprising a primer layer, an electrocoat layer, a powder coat layer, or combinations thereof.

20. A system for treating a metal substrate comprising:
a sealing composition having a pH of 9.5 to 12.5 and comprising a lithium metal cation; and
an aqueous composition comprising a conditioner;
wherein at least a portion of a surface of the substrate is anodized.

21. The system of claim 20, wherein the aqueous composition is for contacting a surface of the metal substrate following contacting with the sealing composition.
